(19) United States
(12) Patent Application Publication
(10) Pub. No.: US 2004/0082076 A1
(43) Pub. Date: Apr. 29, 2004

(54) Device and method for the non-contact application of micro-droplets on a substrate

(76) Inventors: Roland Zengerle, Villingen-Schwenningen (DE); Bas De Heij, Brigachtal (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/362,197

(22) PCT Filed: Feb. 16, 2001
(86) PCT No.: PCT/EP01/01747

(30) Foreign Application Priority Data
Aug. 24, 2000 (DE) 10041536.9-51

(51) Int. Cl. G01N 1/10

(52) U.S. Cl. 436/180; 422/100

(57) ABSTRACT

A device for applying a plurality of microdroplets onto a substrate comprises a dosing head substrate (10) having a plurality of nozzle openings (16) formed therein. For each nozzle opening (16), there is provided a media portion (18) to be filled with a liquid to be dosed. There is provided a deformable component (28) that is arranged adjacent the media portions (18). Finally, the device comprises an actuating means (34) for actuating the deformable component (30) such that the deformable component (30) deforms into the media portions (18) so as to simultaneously expel microdroplets from the plurality of nozzle openings (16).

### DESCRIPTION

The present invention relates to devices and methods for the non-contacting application of microdroplets onto a substrate, and in particular to such devices and methods permitting the simultaneous application of a plurality of microdroplets.

Such devices and methods are suited in particular for producing so-called biochips in which a plurality of different analytes is applied to a substrate so as to detect different substances in an unknown sample.

The increasing degree to which the genomes of human beings, animals and plants are deciphered creates a multiplicity of new possibilities, from the diagnosis of genetically induced diseases to the considerably faster search for pharmaceutically interesting substances. The above-mentioned biochips will be used in the future, for example, for examining food with respect to a multiplicity of possible, genetically modified constituents. In another field of application, such biochips may be used for detecting the precise genetic defect in case of genetically induced diseases in order to derive therefrom the ideal strategy for the treatment of the disease.

The biochips usable for such applications, as a rule, consist of a carrier material, i.e. a substrate, having applied thereto a multiplicity of different substances in the form of a raster. Typical raster distances in the array range from 100 μm to 2,500 μm. The variety of different substances, which are referred to as so-called analytes, on a biochip ranges from a few different substances to several 100,000 different substances per substrate, depending on the particular application. Each of these different analytes can be used for detecting a specific substance in an unknown sample.

When an unknown sample liquid is applied to a biochip, reactions occur in case of specific analytes that can be detected by way of suitable methods, for example fluorescence detection. The number of different analytes on the biochip corresponds to the number of different constituents in the unknown sample liquid that can be analyzed simultaneously by means of the respective biochip. Such a biochip is therefore a diagnostic tool by means of which an unknown sample can be examined with respect to a multiplicity of constituents simultaneously and purposefully.

For applying the analytes to a substrate in order to produce such a biochip, there are presently three fundamentally different methods known. These methods are employed alternatively, depending on the number of biochips required and the number of required analytes per chip.

The first method is referred to as “contact printing”; this method makes use of a bundle of steel capillaries filled with different analytes in the interior thereof. This bundle of steel capillaries is stamped onto the substrate. Upon lifting off of the bundle, the analytes adhere to the substrate in the form of microdroplets. In this method, however, the quality of the printing pattern is determined very much by the effect of capillary forces and, consequently, is dependent upon a multiplicity of parameters, for example the quality of and the coating on the surface of the substrate, the exact geometry of the nozzle and, above all, the media used. In addition thereto, the method is very susceptible to contamination of the substrate and the steel capillaries. The method just described is suited for a variety of analytes of up to a few hundred per substrate.

A second method of producing biochips, the so-called “spotting”, mostly uses so-called microdispensers which, similarly to ink-jet printers, are capable of firing individual microdroplets of a liquid onto a substrate in response to a corresponding control command. Such a method is referred to as “drop-on-demand”. Such microdispensers are commercially available from several companies. The advantage of this method resides in that the analytes can be applied to a substrate in non-contacting manner, with the effect of capillary forces being irrelevant. However, an essential problem consists in that it is very expensive and extremely difficult to arrange a multiplicity of nozzles, each having supplied thereto a different medium, in parallel or in an array. The limiting element in this regard is the actorics as well as the media logistics, which cannot be miniaturized to the desired extent.

A third method used nowadays for producing biochips is the so-called “synthesis method” in which the analytes, consisting as a rule of a chain of linked nucleic acids, are produced chemically on the substrate, i.e. synthesized. For delimiting the spatial position of the different analytes, methods are employed as known from the field of microelectronics, e.g. lithographic methods with masking techniques. However, from the methods mentioned, this synthesis method is by far the most expensive one, but it permits the production of the greatest variety of analytes on a chip, which is in the order of magnitude of 100,000 different analytes per substrate.

The document DE 19802368 C1 reveals a microdosage device which permits several microdroplets to be applied to a substrate through a plurality of nozzle openings. Each nozzle opening is connected via a fluid line to a pressure chamber which, in turn, can be filled with liquid from a reservoir via fluid lines. Each pressure chamber is partly limited by a displacer that is adapted to be actuated by an actuating means for effecting a volume displacement in the pressure chamber so as to eject a droplet from a nozzle opening. According to DE 19802368 C1, it is necessary to provide for each pressure chamber a separate actuating means consisting of a displacer in direct contact with the liquid to be dosed and of an associated actuating element.

The document DE 3123796 A1 discloses an ink ejection device for an ink-jet printer, making use of a buffer medium for acting on an ink layer arranged in front of a nozzle opening so as to eject ink droplets from the nozzle opening. This document relates to an ejection device permitting the ejection of individual droplets from individual ejection openings.

The still unpublished German application DE 19913076 reveals a printhead for applying microdroplets onto a substrate, in which a plurality of nozzles is arranged parallel to each other. The nozzle ends are in contact with a pressure chamber filled with a buffer medium. Via the buffer medium, which usually is air, a pressure pulse can be applied to the ends of liquid columns formed at the nozzles, which are remote from the nozzle openings, so that a plurality of microdroplets can be issued from the nozzles simultaneously. To this end, said DE 19913076 requires a pressure generating means for generating the pressure pulse. The pressure pulse may be generated, for example, by compression of an enclosed volume. In accordance with the behavior of compressible media, e.g. air, a volume reduction in the pressure chamber results in a pressure increase in the same. However, this kind of triggering the nozzles via a pressure pulses involves several advantages. For example, the compressibility of the buffer medium reduces the speed of the pressure increase over time, i.e. the dynamics, as well as the amplitude of the pressure pulse. This has the effect that narrower nozzles, using the system according to DE 19913076, cannot be used any more for dosing media of higher viscosity. Another disadvantage resides in that the reaction of a nozzle to a defined pressure pulse may be very different, depending on the nozzle geometry, i.e. the flow resistance, inductance etc., and on the medium, i.e. viscosity, surface tension thereof, etc. A nozzle of smaller to a defined pressure pulse may be very different, depending on the nozzle geometry, i.e. the flow resistance, inductance etc., and on the medium, i.e. viscosity, surface tension thereof, etc. A nozzle of smaller nozzle diameter, for example, has a greater flow resistance so that the liquid in this nozzle, with the pressure pulse being the same, will be set into motion much more slowly and possibly will no longer reach the necessary speed of approx. 1 to 2 m/s which would be required to allow a liquid droplet to tear off at the nozzle.

It may thus be summarized that the solution approach disclosed in the not pre-published DE 19913076, nozzles of different kind, depending on the geometry and the liquid contained therein, react quite differently to the application of one and the same pressure, so that the method using triggering of a plurality of microdroplets from different nozzles with the aid of a pressure generating means is not optimum.

The document EP-A-670218 discloses a device for ejecting ink from a plurality of nozzle openings. Such a device comprises a nozzle plate with a plurality of nozzle openings, a channel plate, an elastic plate, a pressure plate and an actuating element. The elastic plate has recesses therein which correspond to channels provided in the channel plate, so that these recesses, together with the corresponding channels in the channel plate, constitute pressure chambers. When pressure is applied to the pressure plate via the actuating member, the elastic plate is compressed, thereby reducing the distance between pressure plate and nozzle plate, so that droplets are ejected from the nozzle openings.

The document U.S. Pat. No. 5,508,200 reveals a plurality of dispenser devices. A first dispenser device operates in the manner of a syringe. A second dispenser device comprises a piezoelectric cylinder adapted to have a shock wave applied thereto in order to thus set free a droplet at the opening of the cylinder. Finally, a third dispenser device shown there permits the ejection of droplets through a plurality of openings by introduction of pressure into a pressure chamber in fluid communication with each of the openings.

It is the object of the present invention to make available devices and methods which, while making use of a simple structure, permit a plurality of microdroplets to be ejected simultaneously from a plurality of nozzle openings in defined manner.

This object is met by devices according to claims 1 and 13 as well as by methods according to claims 20 and 21.

The present invention provides a device for applying a multiplicity of microdroplets onto a substrate, comprising:

a dosing head substrate having a plurality of nozzle openings formed therein;

a media portion for each nozzle opening, to be filled with a liquid to be dosed;

media portions so as to simultaneously expel microdroplets from the plurality of nozzle openings.

The present invention is based on the finding that it is advantageous to effect the ejection of microdroplets through a plurality of nozzle openings not by way of a pressure pulse, but by way of direct displacement. According to the invention, a converter principle is employed in which the movement of an external actuator is transferred directly to the liquid contained in the nozzles. A defined quantity of liquid in each nozzle can thus be set into motion, optionally even along with a defined behavior in terms of time.

According to the invention, there is necessary only one actuating means in order to simultaneously effect the ejection of microdroplets from the nozzle openings by means of a single deformable component adjacent all media portions.

As an alternative, it is however also possible to subdivide a plurality of nozzle openings into individual sub-quantities. Each sub-quantity still contains a plurality of nozzle openings, and the sub-quantities can each be triggered separately from each other.

The deformable component constitutes a volume displacement means for simultaneous volume displacement in all media portions of the plurality of nozzle openings, through which mechanical motion of an external actuator is transformed much more efficiently into movement of the liquids contained in the nozzles, i.e. the media portions with the associated nozzle openings. Due to the fact that, according to the invention, it is in essence the deformation, and not the pressure, that is preset, liquids with different viscosity in the nozzles will be set into motion in nearly identical manner.

The present invention, furthermore, provides a device for applying a plurality of microdroplets onto a substrate, comprising:

a dosing head substrate consisting of a deformable material and having a plurality of nozzle openings formed therein,

the dosing head substrate for each nozzle opening having a media portion formed therein that is to be filled with a liquid to be dosed; and

a means for effecting deformation of the dosing head substrate so as to simultaneously expel microdroplets from the plurality of nozzle openings.

With such a means, the above-described volume displacement in the respective media portions can be effected by deformation of the dosing head substrate itself, in which the media portions are formed. Preferably, this deformation is effected by arranging the deformable dosing head substrate between two rigid plates between which relative movement is effected, resulting in a corresponding deformation of the dosing head substrate.

Furthermore, the present invention provides a device for applying a plurality of microdroplets onto a substrate, comprising:

a dosing head substrate having a plurality of nozzle openings formed therein;

a media portion for each nozzle opening, which is to be filled with a liquid to be dosed, each media portion having a separate buffer media portion associated therewith which is adjacent the media portion;

a deformable component adjacent the buffer media portions; and

an actuating means for actuating the deformable component such that the deformable component is deformed into the buffer media portions so as to effect, via the buffer media portions, a displacement of the liquid to be dosed from the media portions in order to thus simultaneously expel microdroplets from the plurality of nozzle openings.

The present invention moreover provides a method of applying a plurality of microdroplets onto a substrate, comprising the steps of:

providing one liquid-filled media portion each on each of a plurality of nozzle openings; and

displacing liquid from each of the media portions by producing a deformation of a deformable component adjacent the media portions, into the media portions so as to eject a microdroplet from each nozzle opening.

According to another aspect, the present invention, furthermore, provides a method of applying a plurality of microdroplets onto a substrate, comprising the steps of:

providing one liquid-filled media portion each on each of a plurality of nozzle openings, the nozzle openings and media portions being formed in a dosing head substrate of a deformable material; and

producing a deformation of the dosing head substrate such that microdroplets are simultaneously expelled from the plurality of nozzle openings.

Finally, the present invention provides, according to still another aspect, a method of applying a plurality of microdroplets onto a substrate, comprising the steps of:

providing one liquid-filled media portion each on a plurality of nozzle openings, each media portion having a separate buffer media portion associated therewith that is adjacent the media portion; and displacing liquid from each of the media portions by producing a deformation of a deformable component adjacent the buffer media portions, into the buffer media portions in order to effect, via the buffer media portions, a displacement of the liquid to be dosed from the media portions so as to thus simultaneously expel microdroplets from the plurality of nozzle openings.

According to the invention, there is thus applied in each case a plurality of microdroplets using a direct displacement, with a deformable component being either directly adjacent a liquid to be dosed or being adjacent thereto via a buffer medium.

In preferred embodiments of the invention, the deformable component or the deformable dosing head substrate consists of a deformable, nearly incompressible medium in order to be thus able to effect a defined volume displacement. A preferred material satisfying these requirements is, for example, an elastomer, e.g. rubber or silicone.

Further developments of the invention are defined in the dependent claims.

Preferred embodiments of the present invention will be explained in more detail hereinafter with reference to the accompanying drawings in which

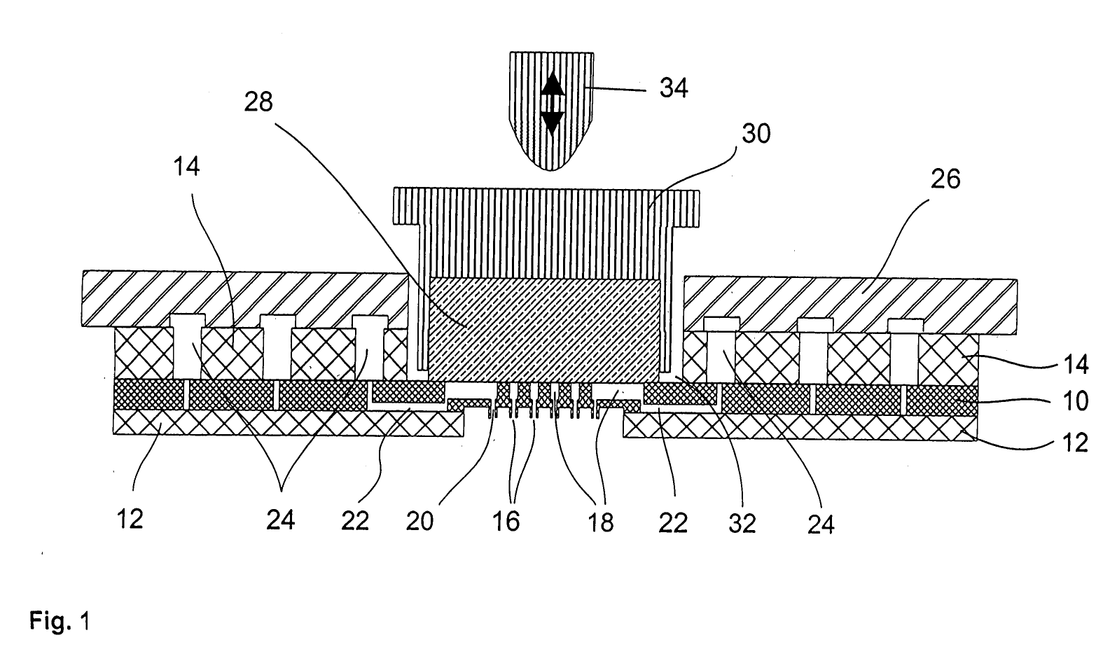

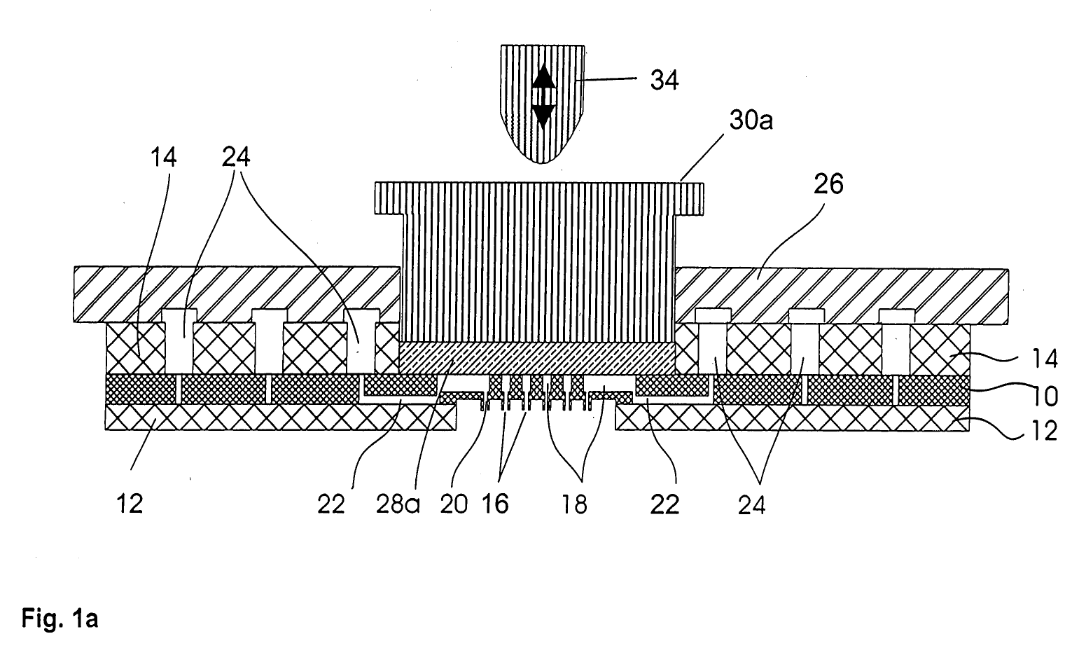

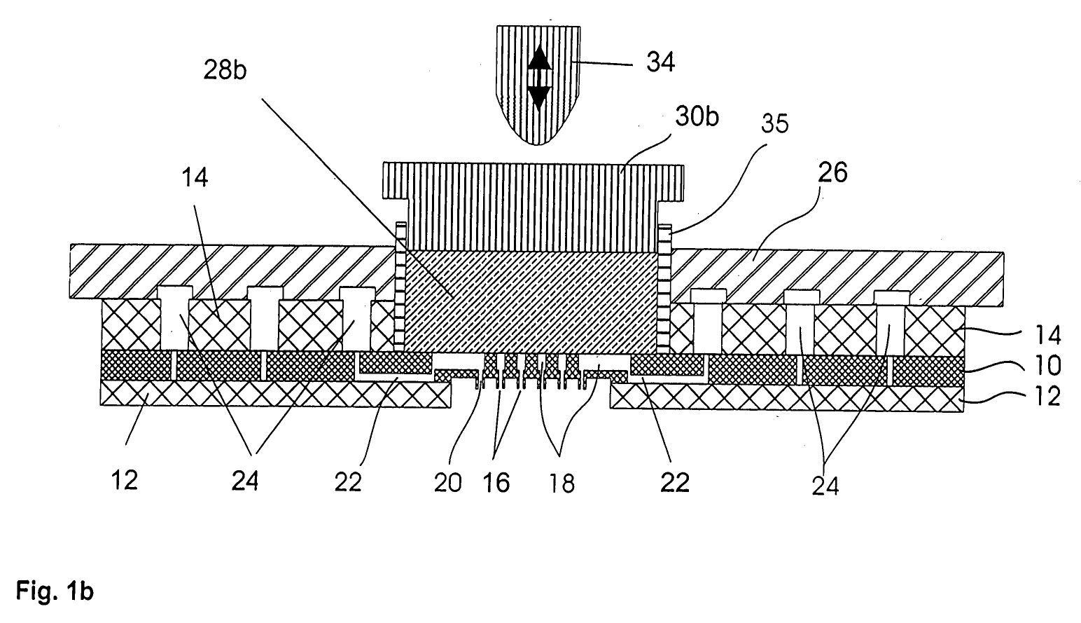

FIG. 1 shows a schematic cross-sectional view of a first embodiment of the present invention;

FIGS. 1a and 1b show modifications of the embodiment illustrated in FIG. 1;

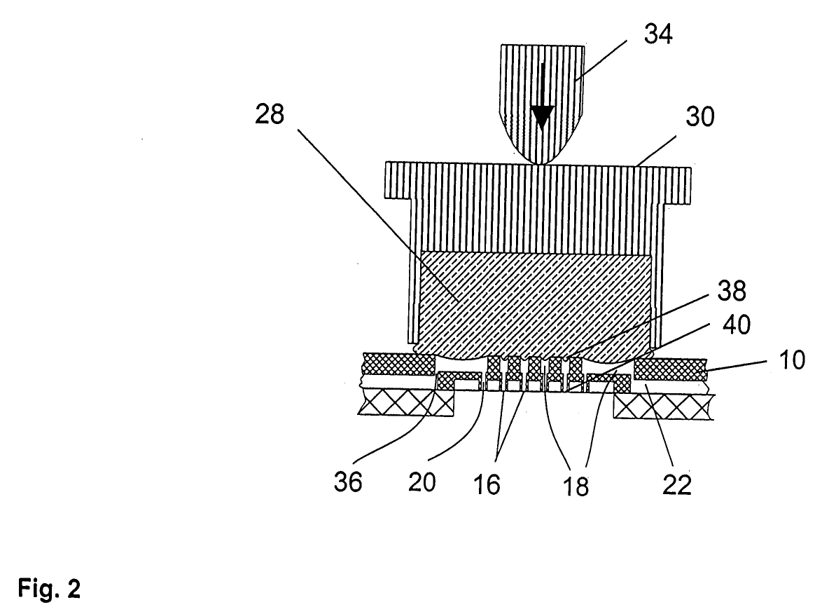

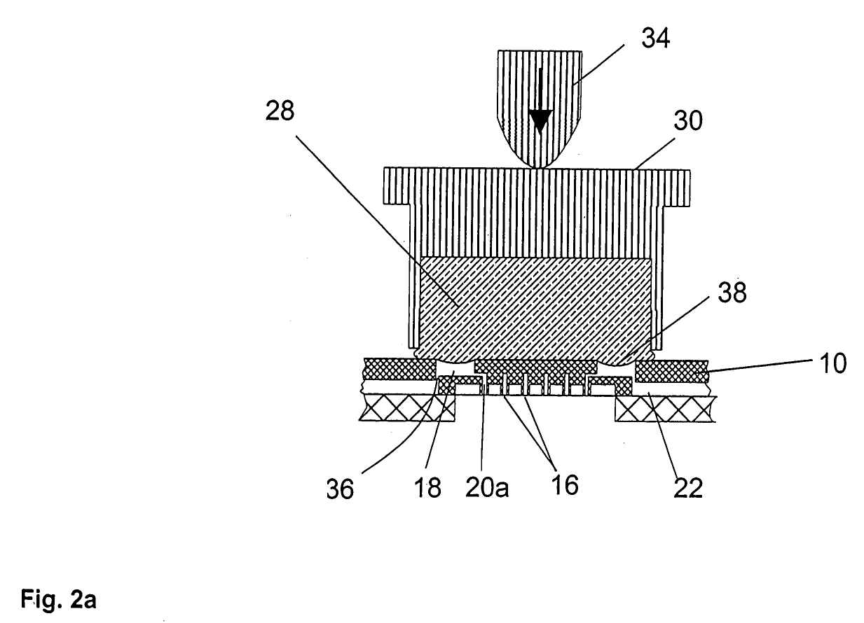

FIG. 2 shows a schematic cross-sectional view of a portion of the embodiment of FIG. 1;

FIG. 2a shows a schematic cross-sectional view of a portion of a modification of the embodiment illustrated in FIG. 2;

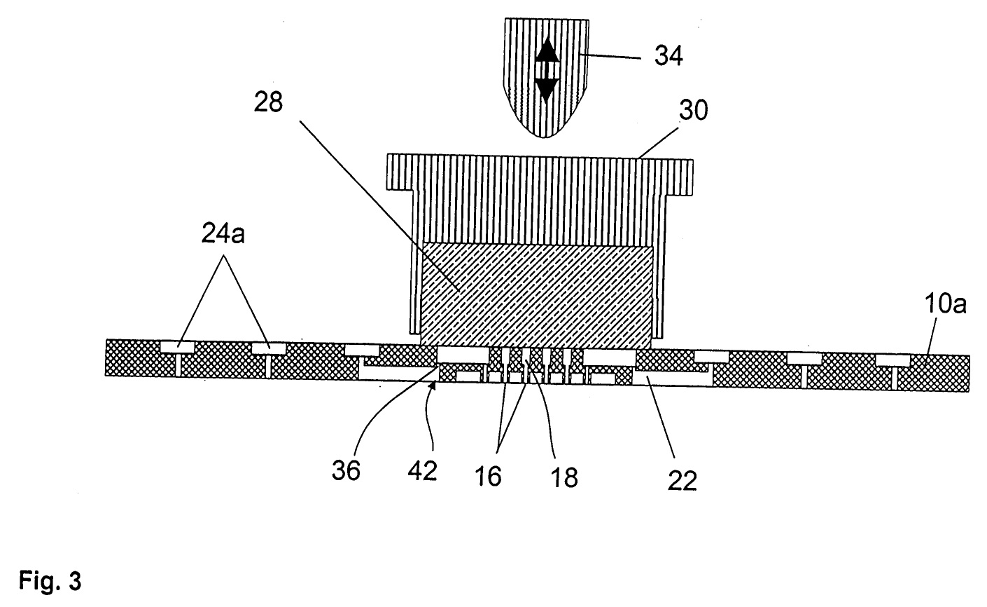

FIGS. 3; 4, 4a, 4b, 4c, 5, 5a, and 6 to 11 show schematic cross-sectional views of respective embodiments of devices for applying microdroplets according to the invention;

FIG. 12 shows a schematic plan view of a dosing head substrate that can be utilized in a device for applying microdroplets according to the invention;

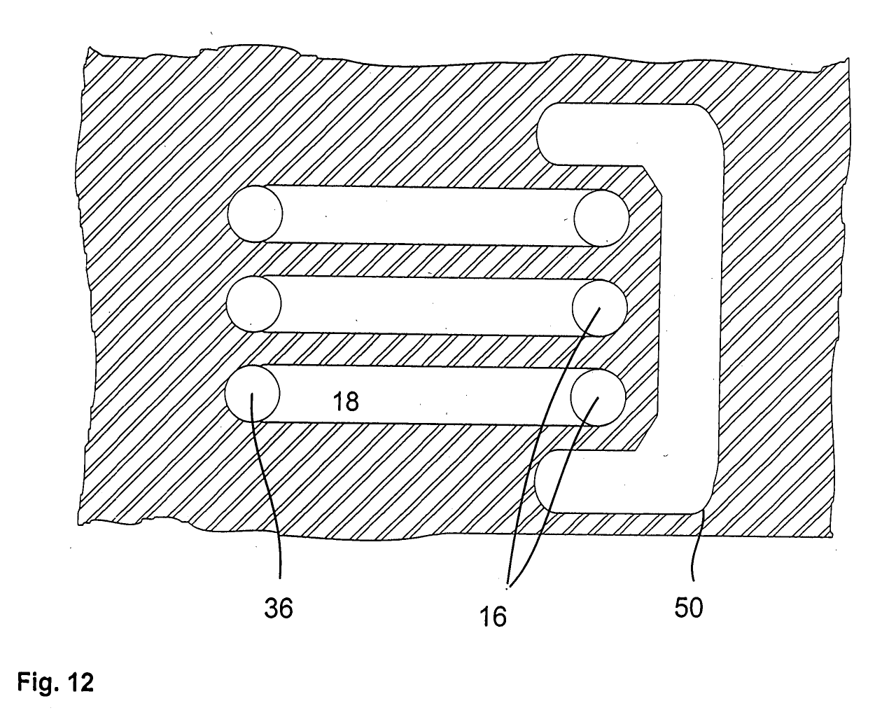

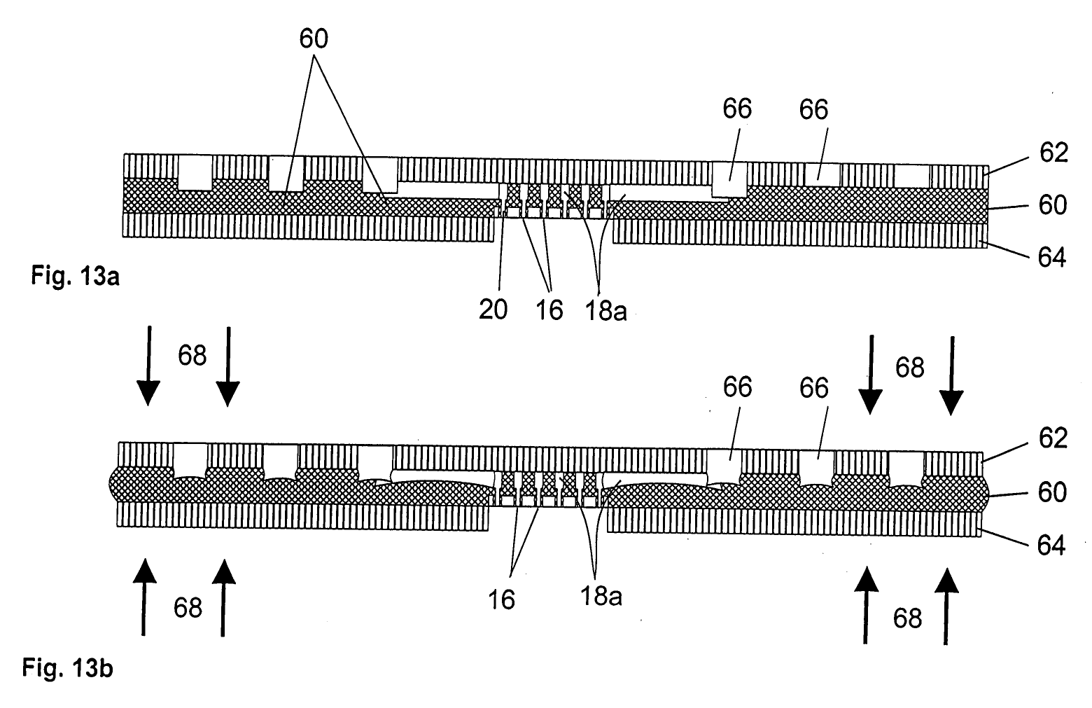

FIGS. 13a and 13b show schematic cross-sectional views of an alternative embodiment of a device for applying microdroplets according to the invention;

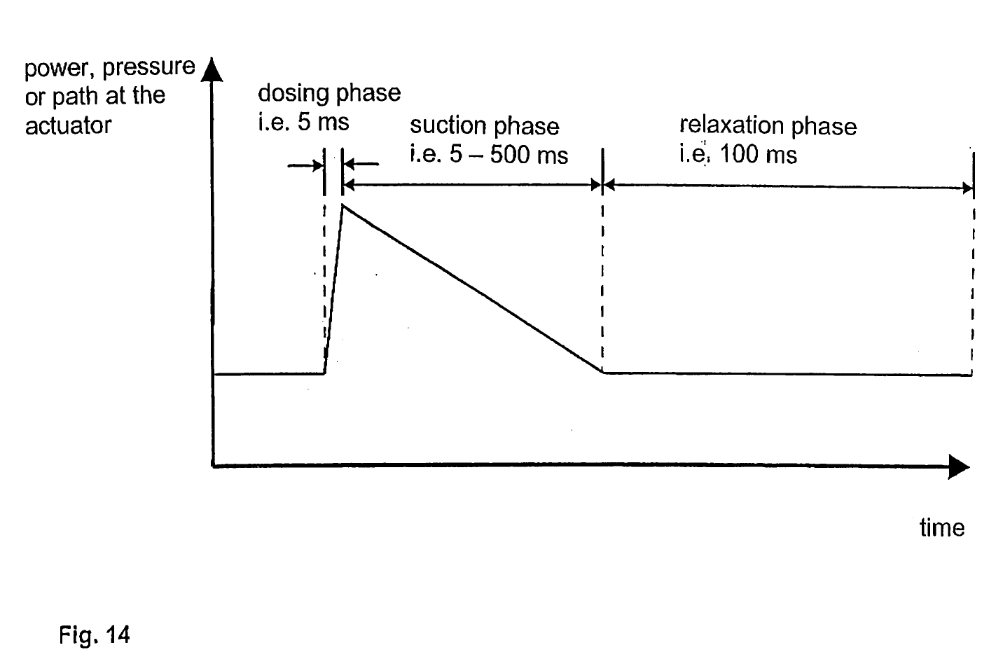

FIGS. 14 to 16 show schematic representations illustrating the operation of the devices according to the invention; and

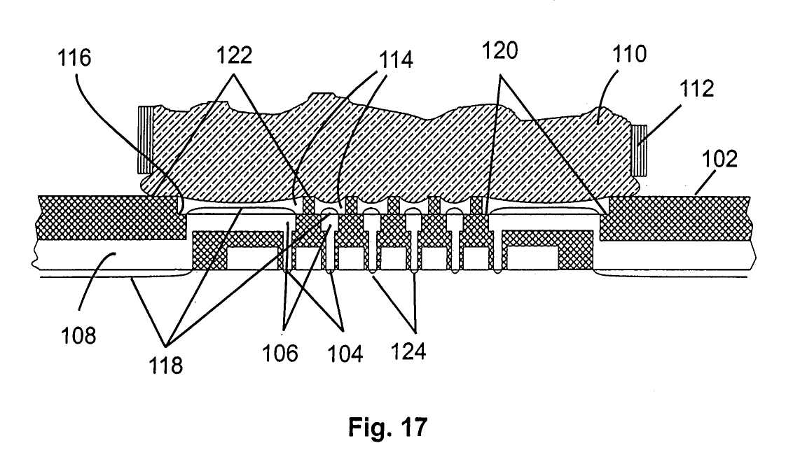

FIG. 17 shows a schematic cross-sectional view of a further embodiment according to the present invention.

FIG. 1 illustrates an embodiment of a device for applying a plurality of microdroplets onto a substrate, according to the invention, in which a dosing head is formed of three functional layers, a dosing head substrate or structural plate 10 and two cover plates 12 and 14.

The structural plate 12 has all microstructures of the device according to the invention formed therein, using e.g. conventional micromechanical processes.

The dosing head substrate 10 has a plurality of nozzles formed therein which have nozzle openings 16 arranged in the underside of the dosing head substrate 10. For example, there may be arranged 6×4 nozzle openings in the underside of the dosing head substrate 10. As shown in FIG. 1, above the nozzle openings 16 in the dosing head substrate 10, there are formed media portions or media compartments that are in fluid communication with the nozzle openings 16. These media portions are filled, or will be filled, with a liquid to be dosed, so that in the embodiment illustrated a liquid column of a medium to be dosed is formed or will be formed on each nozzle opening 16. In the embodiment illustrated, the media portions comprise a portion 18 having a volume displacement means adjacent thereto, which will be described later on, and a nozzle portion 20 establishing fluid communication with the nozzle openings 16.

The respective nozzles preferably are of such a size that capillary filling thereof is possible. As an alternative, the nozzles can be filled, for example, by means of gravimetric processes, pressure-controlled processes and the like. The nozzle openings, furthermore, are micro-structured in the underside of the dosing head substrate 10 preferably such that they are exposed with respect to the surrounding surface. The dosing head substrate preferably consists of silicon and is structured using corresponding techniques, but may also consist of injection-molded plastics material or the like.

As illustrated in FIG. 1, the media portions 18, 20, furthermore, are connected, via supply lines 22, to reservoir portions 24 formed in the upper cover plate 14. It is apparent that the supply lines may be designed in a multiplicity of ways; for example, there may also be provided several parallel lines connecting the same reservoir portion to the same media portion.

Each media portion is connected via such a supply line 22 to the respective reservoir portion 24, with FIG. 1 showing merely the supply line to two media portions due to the cross-sectional representation thereof.

Above the upper cover plate 14, the embodiment illustrated has an optional covering plate 26 arranged thereon that may be designed as a cooling plate to reduce evaporation. The lower cover plate 12 provided in this embodiment serves for covering the supply channels 22 as well as for mechanical stabilization. The upper cover plate 14, as pointed out hereinbefore, serves for enlargement or provision of reservoir portions and, in addition thereto, also for mechanical stabilization.

In the central region of the device illustrated schematically in FIG. 1, there is provided a volume displacement means in the form of a separate component. The volume displacement means comprises a deformable material 28 which, in the embodiment illustrated, is introduced into a socket 30. The underside of the deformable material is placed onto the rear side of the nozzles such that the deformable component or deformable material 28 is adjacent openings of the media portions 18 that are remote from the nozzle openings 16. The socket 30 surrounds the majority of the deformable component, except for the portions in which said component is adjacent the dosing head substrate 10 or the recessed portions thereof; however, in the embodiment illustrated there is provided a free portion 32 above the dosing head substrate 10 so as to permit relative movement of the socket 30 with respect to the dosing head substrate 10. Such movement can be effected, for example, by a piezo stack actuator 34. However, as an alternative, other actuating means or macroscopic actuators may be used as well, for example piezoelectric bending transducers or other piezoelectric materials, electromagnetic drives, pneumatically driven pistons, pistons driven by a mechanically biased spring, and the like.

In any event, the socket 30 and the dosing head substrate 10 are designed and arranged in relation to each other such that relative movement is rendered possible between the same. Furthermore, the deformable component 28 preferably is arranged between the socket 30 and the dosing head substrate 10 such that the rear sides of the nozzles, i.e. the openings of the media portions 18, 20 facing the deformable component 28, as well as the top sides of the supply lines 22 are sealed with respect to each other, so that there can be no cross-contamination of liquids from different nozzles taking place. This can also be achieved, for example, by connecting the socket along with the deformable component to the dosing head substrate with a certain bias also in the inoperative state.

It is to be pointed out here that the term media portion or media compartment is used herein for defining a liquid-containing portion at the nozzle opening 30 so that liquid displacement from this portion through the nozzle opening is rendered possible by means of the deformable component. It is immaterial for the basic mode of operation at which precise location of the media portion the displacement by means of the deformable component takes place.

FIGS. 1a and 1b illustrate modifications of the embodiment illustrated in FIG. 1. In case of the modification shown in FIG. 1a, a deformable component 28a is enclosed in the cover plate 14 of the substrate 10, and only the upper side of the deformable component 28a is covered by a movable socket. In case of the modification shown in FIG. 1b, there is provided a separate component 35 having a deformable component 28b adjacent the lateral surfaces thereof. A movable socket 30b again acts solely on the top side of the deformable component 28b.

In the following, the mode of operation of the embodiment illustrated in FIG. 1 shall be described in more detail with further reference to FIG. 2.

In the stationary state, i.e. prior to an ejection operation, the ends of the liquids contained in the media portions associated with the nozzles are located at the nozzle openings 16. In this regard, as pointed out hereinbefore, the nozzles are preferably designed such that capillary forces move the liquids as far as the nozzle openings; at the nozzle openings 16 there are surface forces, resulting from the increasing surface of the liquid upon formation of a droplet, which hinder the liquid from leaving the nozzle openings 16.

Furthermore, the supply lines 22 are preferably designed such that solely capillary filling of the nozzles from the reservoir 24 is rendered possible.

Starting from this state, it is possible by means of the actuating member 34, which in the embodiment illustrated is a piezo stack actuator, to exert a defined force, a defined pressure or a defined displacement onto the socket 30. Due to this, the deformable component 28 is urged against the top side of the dosing head substrate 10 so that, as pointed out hereinbefore, the nozzles are sealed relative to each other. It is thus prevented that cross-contamination of liquids from several nozzles can take place during the ejection operation. When the pressure, the defined force or the defined displacement applied to socket 30 is increased, the deformable material 28 will expand into the media portions associated with the respective nozzles to a defined extent. In doing so, a defined quantity of liquid will be displaced from each nozzle. This deformation of the deformable component 28, taking place in the portions thereof that are not covered by the socket 30 and the dosing head substrate 10, respectively, is illustrated in FIG. 2. It is apparent that, in this embodiment, the socket 30 and the dosing head substrate 10 consist of a substantially rigid material.

If the above-described process of expansion of the deformable component to a defined extent into the respective nozzles takes place with sufficiently high dynamics and sufficiently high amplitude, liquid droplets will be discharged simultaneously to an underlying substrate in non-contacting manner.

Due to the volume displacement means, as formed by the deformable component according to the invention, the mechanical movement of an external actuator is efficiently transferred into motion of the liquids contained in the nozzles. Due to the structure illustrated, the deformation or volume displacement, and not the pressure, is substantially predefined, so that also liquids of different viscosity are set into motion in the nozzles in substantially identical fashion. According to the invention, this is rendered possible by the rigid socket 30 by means of which regions can be defined into which the deformable component 28 or the deformable material can expand. The volume displacement thus may be focussed mainly on the nozzles and connected supply lines. Just a minor part of the volume displacement is, so to speak, lost in the portion 32 between socket 30 and dosing head substrate 10, i.e. this part does not contribute to the ejection of microdroplets.

As was already pointed out hereinbefore, in the stationary state, the liquids are at the nozzle openings 16 due to capillary forces and surface forces. If the liquids or the ends of the liquid columns are outside of the stationary state, i.e. not at the nozzle openings 16, there are relaxation forces active, namely the afore-mentioned capillary forces and surface forces, tending to restore this state. The time constants for these relaxations are dependent both upon the flow resistances of the respective liquids in the nozzles and on the flow resistances in the media feed lines, i.e. in the supply lines 22, to the nozzles as well as on the mass of the liquids contained in the media feed lines. An essential prerequisite for the discharge of liquid droplets is that the volume displacement of the deformable material in the nozzles takes place faster than the relaxation of the liquid flows. For ejecting microdroplets from the nozzle openings 16, a decisive role, apart from the displacement generated as such by the deformable component 28, thus resides above all in the rapid change in displacement produced by the deformable component 28.

The dosed quantity of liquid ejected at the nozzle openings can be obtained via a variation of the force, displacement or the pressure generated by the actuator 34 displacing the deformable component 28 via the rigid socket 30. In addition thereto, the dosed quantity can be adjusted by varying the dynamics driving the deformable component, i.e. in particular the speed acting on the liquid in the nozzles.

Due to the deformation of the deformable component 28 into the media portions associated with the nozzles, microdroplets are ejected from the nozzle openings 16 in accordance with the description given hereinbefore. In doing so, liquid is displaced from the media portions associated with the respective nozzle openings, with liquid being displaced from the supply lines 18 as well. A certain volumetric share of the displacement moves liquid in the direction of the nozzle, the remainder resulting in backflow towards the reservoir. The absolute values of these liquid quantities are dependent upon several parameters, e.g. the amplitude of the displacement, the flow resistances and the inductances. However, it is not decisive for the function that a specific relation is present between the flow resistances or inductances to the nozzle and the reservoirs or that this relation can be expressed in exact figures. Rather, it is sufficient that the situation can be defined or reproduced in any way whatsoever. For example, a percentage of 20% of the displacement towards the nozzle would be sufficient for ejecting liquid there.

It is preferred in this respect that the supply channels have at least one portion 36 with a flow resistance in order to uncouple the media portions associated with the nozzles, e.g. portions 18 and 20, from the supply lines 22. The effect obtainable thereby is, for example, that the percentage of the displacement in the direction towards the nozzle is e.g. 80%. However, this is no cogent prerequisite for the functioning of the dosing head.

For example, the supply lines may have a portion 36 having a flow resistance that is higher than the flow resistance of the nozzle channels 20 so that the deformation of the deformable component 28 contributes in essence to ejection of microdroplets and not to backflow of liquid through the supply channels 22 to the reservoirs 24. A through opening 36 having a defined, low flow resistance can be produced in a silicon substrate preferably by producing a first elongate trench structure of defined width and depth in a first surface of the substrate and by producing a second elongate trench structure of defined width and depth in a second surface of the substrate opposite said first surface, such that the first and second trench structures are intersecting so as to form at the intersection an opening having the defined cross-sectional area.

As an alternative, such a flow resistance may also be generated by a local constriction of a channel extending in a surface.

In preferred embodiments, the media feed lines to the nozzles, i.e. the openings of the portions 18 in the dosing head substrate 10 facing the deformable component 28 and confined by the deformable component 28, are designed to have identical profiles of the cross-sectional areas 38 for the various nozzles. This has the effect that identical conditions are present at all nozzles as regards the displacement of the deformable component 28. In addition thereto, it is possible to match the displaced volume in the individual nozzles by matching of the cross-sectional areas 38 in FIG. 2. In particular, by way of larger cross-sectional-areas' of individual nozzles, it is possible to discharge a larger liquid quantity there.

In addition thereto, in preferred embodiments, the diameter of the portion 18 of the nozzle, at the location 38 (FIG. 2) where the rear side of the nozzle is adjacent the deformable component 28, is made clearly greater than at the location 40 (FIG. 2) of liquid discharge, i.e. nozzle opening 16. It is thus possible more easily to move the deformable component 28 into the nozzles. In addition thereto, this constitutes a kind of hydraulic translation, i.e. a small axial movement on the side 38 of large nozzle diameter effects a large axial movement of the liquid on the side 40 of small nozzle diameter.

FIG. 2a illustrates a modification of the embodiment shown in FIG. 2, in which the media portion 18, into which the displacement of the deformable component 28 takes place, is not arranged directly above the nozzles 16. Rather, there is provided a nozzle channel 20a having a bend or kink between media portion 18 and nozzle opening 16.

In the following, there will be explained alternative embodiments of the invention with reference to FIGS. 3 to 9 in which elements corresponding to those of FIG. 1 are designated with the same reference numerals.

FIG. 3 illustrates an embodiment of a device according to the invention having a particularly simple one-layered structure. In the embodiment illustrated in FIG. 3, fluid reservoirs 24a are formed in the top side of a dosing head substrate 10a, the reservoirs 24a in turn being connected via respective supply lines 22 to the respective nozzles or media portions associated therewith. As this embodiment is not provided with cover plates, the media lines have to be designed such that the liquids are held therein by capillary forces. In addition thereto, it is necessary in this embodiment to provide in each supply line 22 a narrow channel 36 having a flow resistance or inductance that is greater than the corresponding parameter, of the nozzle connected to this supply line. In generating a microdroplet discharge by deformation of the deformable component 28 into the openings in the dosing head substrate 10a, it is thus possible to prevent an ejection of liquid via the bottom side of the supply lines 22, for example in region 42 of FIG. 3. A through opening with a defined cross-sectional area for determining a corresponding flow resistance can be produced in the manner described above.

With this embodiment, the filling of the nozzles again takes place preferably solely by way of capillary forces having the effect that the liquid is fed through the supply lines to the connected nozzle, at the surface of which the surface energy again has the effect of preventing a liquid discharge.

The volume displacement means, consisting of deformable component 28, socket 30 and actuator 34, corresponds to the volume displacement means described with reference to FIG. 1, and with respect to the mode of operation of the embodiment illustrated in FIG. 3 reference is also made to the corresponding description of the embodiment illustrated in FIG. 1.

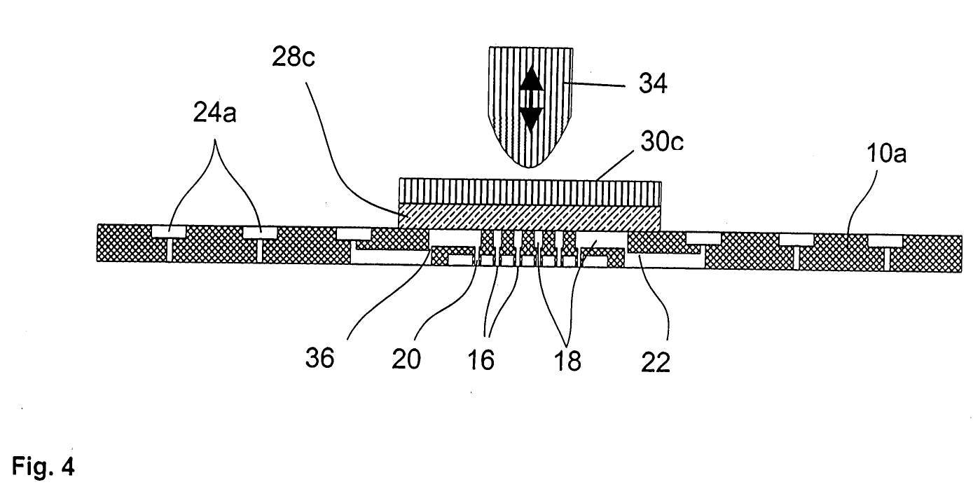

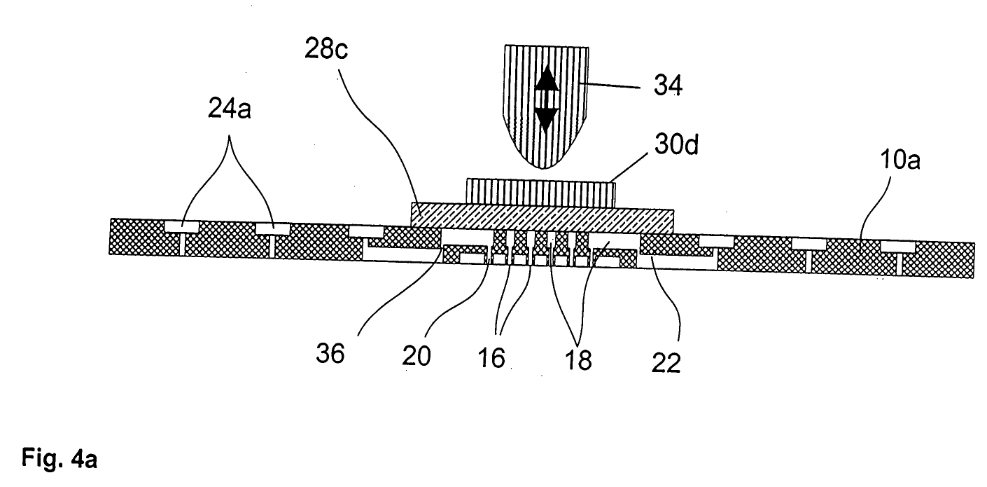

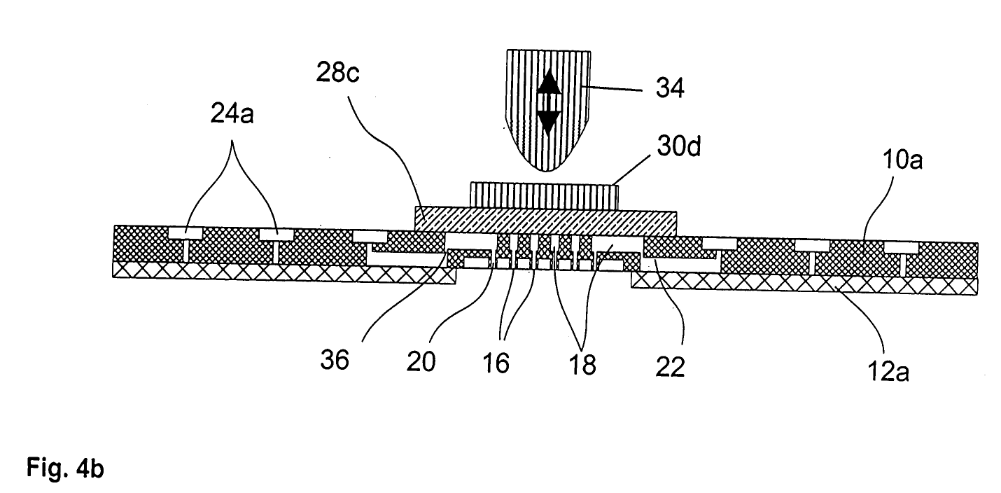

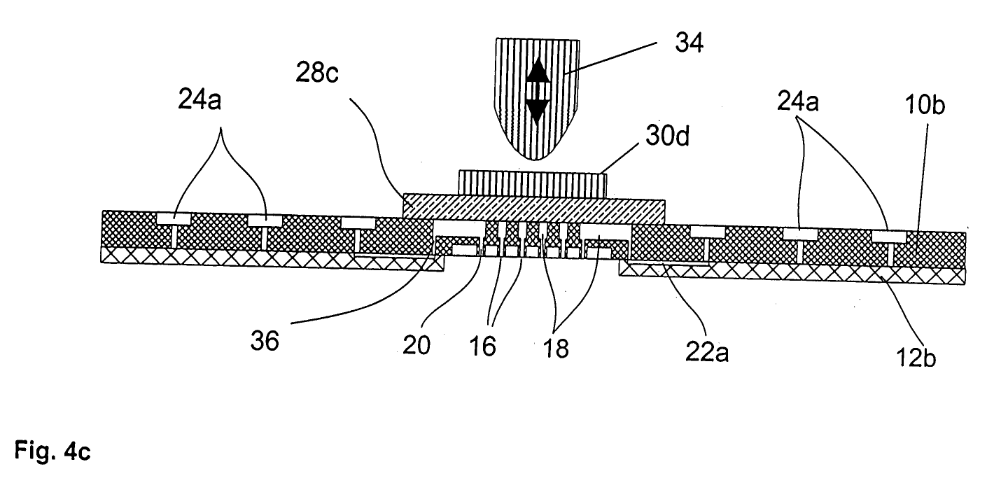

FIG. 4 illustrates an embodiment of a device according to the invention having a modified displacer, with the construction of the dosing head substrate 10a corresponding to the construction shown in FIG. 3. However, it is apparent that a dosing head corresponding to a different embodiment described may be used in the embodiment according to FIG. 4. In the embodiment shown in FIG. 4, a deformable component 28c is of sheet-like design, for example in the form of a plate. In such a case, it is sufficient to provide as socket a flat plate 30c preventing evasion of the deformable component 28c to the rear side. The sheet-like design of the deformable component 28c as such has the effect that the material thereof, upon operation of the actuator 34, is deformed preferably into the recesses of the dosing head substrate 10a facing the deformable component 28c, and not through open lateral surfaces since the open lateral surfaces are inherently small due to the sheet-like design of the deformable component 28. As for the rest, the above statements concerning the mode of operation are applicable in corresponding manner for the embodiment illustrated in FIG. 4.

In the embodiment illustrated in FIG. 4a, the socket plate or actuator plate 30d is sufficiently small to fit between the through openings 36. Thus, with this embodiment, the fluid resistance is of lesser significance. According to FIG. 4b, a cover plate 12b is provided on the bottom surface of the substrate 10a, comparable to the embodiments illustrated in FIGS. 1, 1a, 1b, 2, and 2a. Thus, with this embodiment, the problems concerning the fluid resistance of the through openings are not present. According to the embodiment illustrated in FIG. 4c, parts of the supply lines 22a to the reservoirs 24a are not provided in the substrate 10b, but in the bottom cover plate 12b.

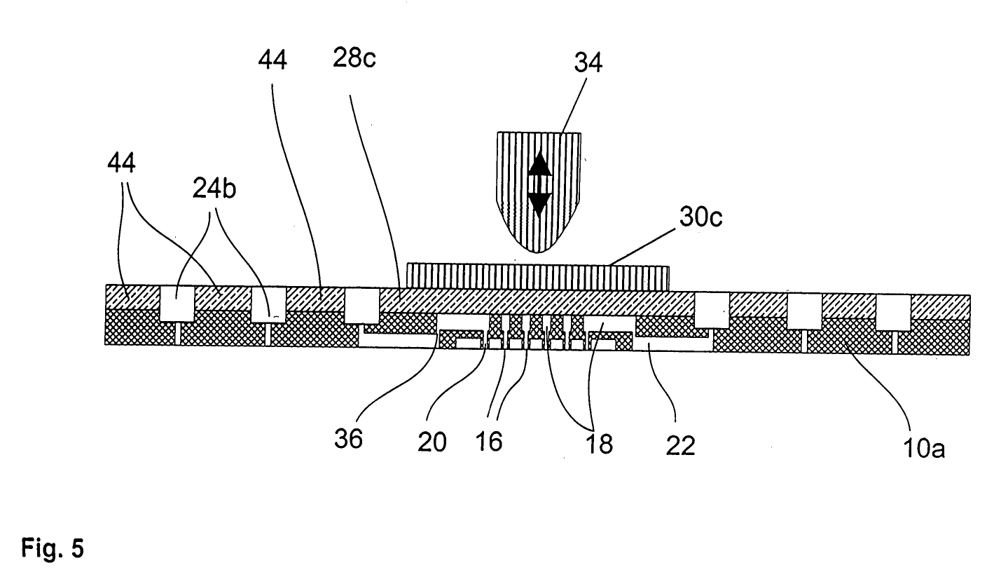

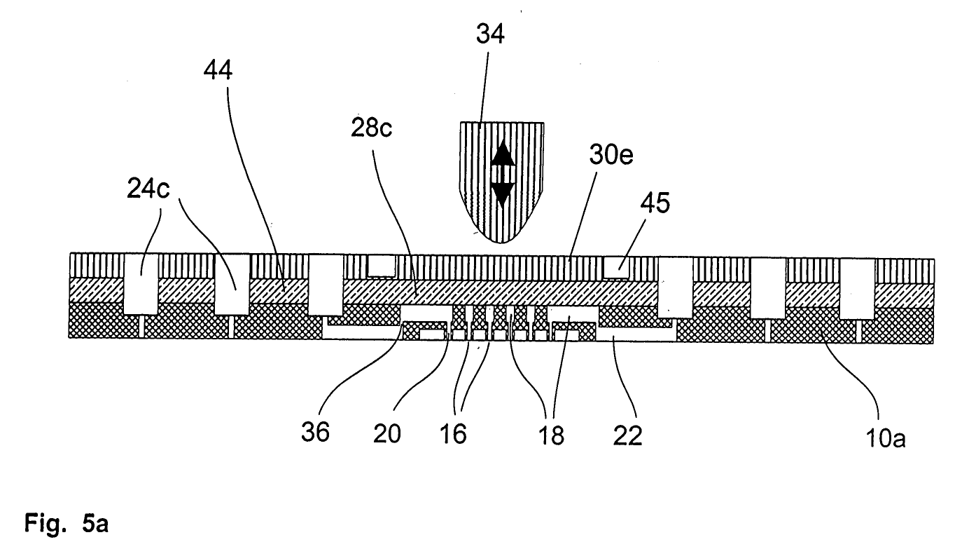

FIG. 5 illustrates an embodiment corresponding substantially to that of FIG. 4, but in which the deformable component 28c is extended as far as the edges of the dosing head substrate 10a, cf. the portions designated 44 in FIG. 5. Furthermore, the extended portions of the deformable material have recesses provided therein which, together with reservoir portions formed in the dosing head substrate 10a, form enlarged reservoirs 24b. Advantageous in this embodiment is the increased filling volume of the reservoirs, with the deformable material of the deformable component 28c being attached e.g. by adhesive forces or gluing.

In accordance with FIG. 5a, the deformable component 28c and the counter-holding means 30e extend over the entire dosing head. Due to this, an additional increase of the reservoirs 24c is obtained. The counter-holding means 30e preferably is structured such that the central portion above the nozzles is uncoupled from the remaining portion, so that the deformable component 28c may be urged into the media compartments locally above the nozzle portion. To this end, the counter-holding means 30e is provided with resilient suspension means 45.

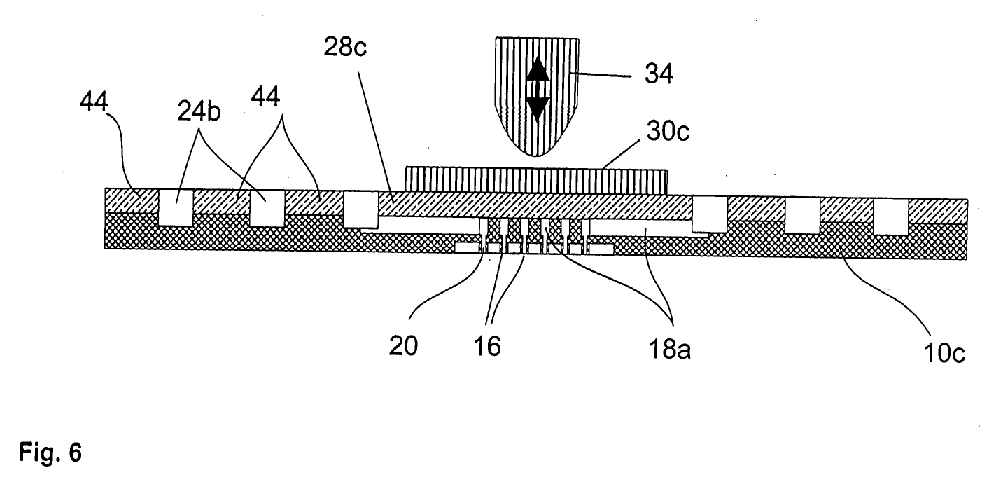

FIG. 6 illustrates an embodiment of a device according to the invention in which the supply lines 18a are formed in the surface of a dosing head substrate 10c facing the volume displacement means. In this case, the sole fluid passages necessary in the dosing head substrate or structural plate 10c are the fluid passages formed by the nozzles. As was already pointed out hereinbefore, the flow resistances need not be expressible in clear figures for the functioning of the devices according to the invention, but merely have to be reproducible and defined in this form.

It is apparent that in case of the embodiments described hereinbefore with reference to FIGS. 1 to 6, at least parts of the volume displacement means may be formed separately from the dosing head. For example, according to FIGS. 1 to 4, the entire volume displacement means, consisting of the deformable component, the counter-holding means, i.e. the support 30 or the plate 30c, and the actuator, may be composed separately from the dosing head so that this volume displacement means can be utilized for a plurality of dosing heads in succession, using e.g. automatic positioning means. In the embodiment shown in FIGS. 5 and 6, the actuator 34 and the counter-holding means 30c may be composed separately so that the same can be used, as outlined above, for a dosing head consisting of a dosing head substrate 10a, 10b and a layer of a deformable material applied thereto.

It is apparent, furthermore, that suitable means, e.g. clamping means, may be utilized for holding the respective arrangement in position.

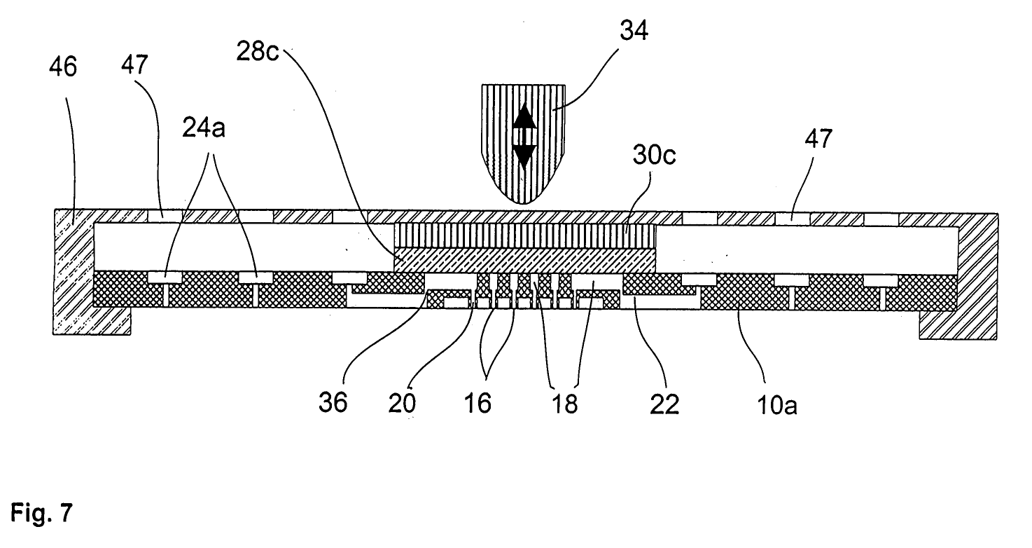

FIG. 7, for example, shows a clamping means 46 consisting of a rigid material for holding together the composite assembly of dosing head substrate 10a, deformable component 28c and counter-holding plate 30c. In this case, the actuator 34 acts on the top side of the clamping means 46 so that a deformation of the deformable component 28c into facing recesses of the dosing head substrate 10a is effected again via the counter-holding means 30c. It is obvious that the provision of such a clamping means 46 furthermore provides for the possibility of dispensing with the separate counter-holding means 30c so that the portion of the clamping means arranged between deformable component 28c and actuator 34 would act directly on the deformable component 28c. The clamping means preferably has openings 47 provided therein, permitting access to the reservoirs 24a and thus also filling of the same. Except for the clamping means 46 for fixing the deformable component and the counter-holding plate, the embodiment illustrated in FIG. 7 corresponds to that shown in FIG. 4; however, it is to be noted in this regard that corresponding clamping means may also be provided for the other embodiments described herein.

It is to be pointed out here that in the dosing devices according to the invention, all layers of the dosing head, the deformable material, the counter-holding plate as well as the dosing head substrate alone, may be connected to each other via a clamping means, so that the pressure head, after use thereof, may be disassembled completely into its individual components for cleaning thereof.

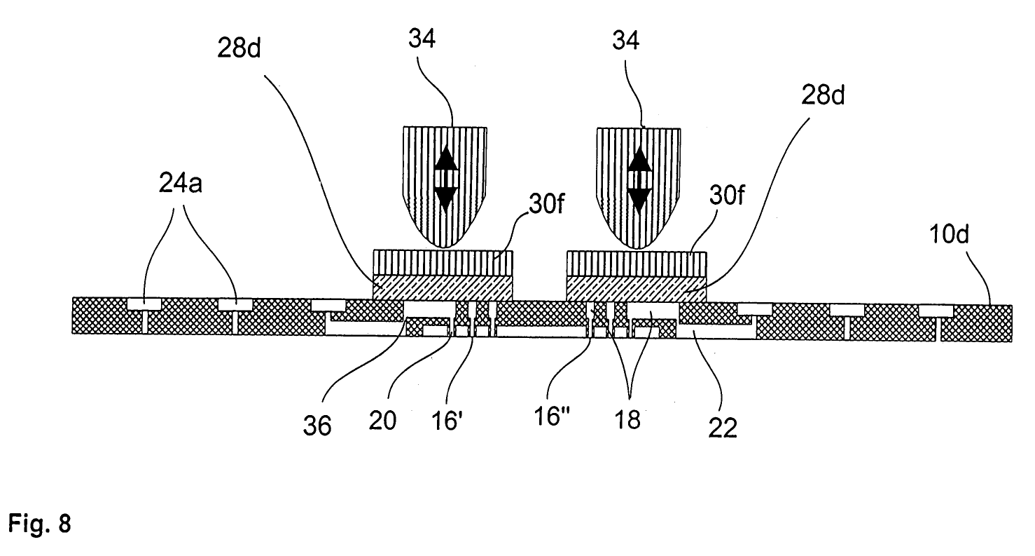

FIG. 8 illustrates an embodiment of a dosing device according to the invention in which the plurality of nozzle openings is subdivided into individual sub-quantities. In the embodiment shown, there are provided e.g. two sub-quantities 16′ and 16″ of nozzles that are each adapted to be driven separately via a deformable component 28d, a counter-holding plate 30f and an actuator 34. The dosing head substrate 10d is structured accordingly to define the sub-quantities of nozzles. It is evident that a theoretically arbitrary number of sub-quantities may be provided as long as each sub-quantity 16′, 16″ still has a plurality of nozzles.

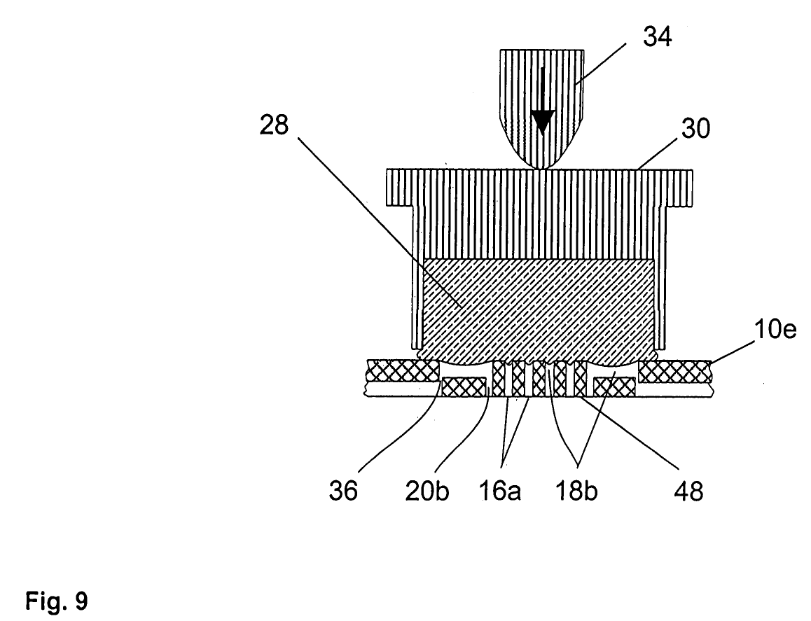

FIG. 9 illustrates an embodiment in which the media portion above the nozzle openings 16a has no different cross-sectional areas, but is defined solely by the nozzle channels 20b and the media feed lines 18b. Furthermore, the bottom side of the dosing head substrate 10e, having the nozzle openings 16a formed therein, has no structuring of the nozzle edges in the present embodiment. The nozzle openings thus are located in a level plane. In this case, it is possible e.g. by a hydrophobic coating 48 on the bottom side or nozzle circumferential edge, to achieve a similar positive effect with respect to the tearing off of the liquid droplets.

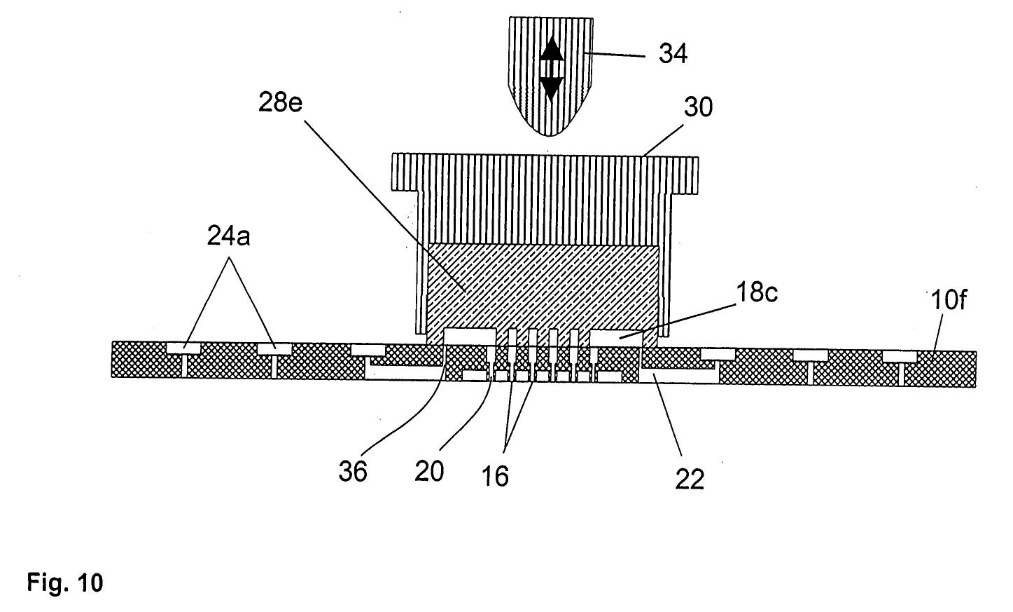

In the embodiment illustrated in FIG. 10, parts 18c, namely parts of the media feed lines, of the media portions associated with the respective nozzles or nozzle openings 16 are formed in the deformable component 28e and not in the dosing head substrate 10f.

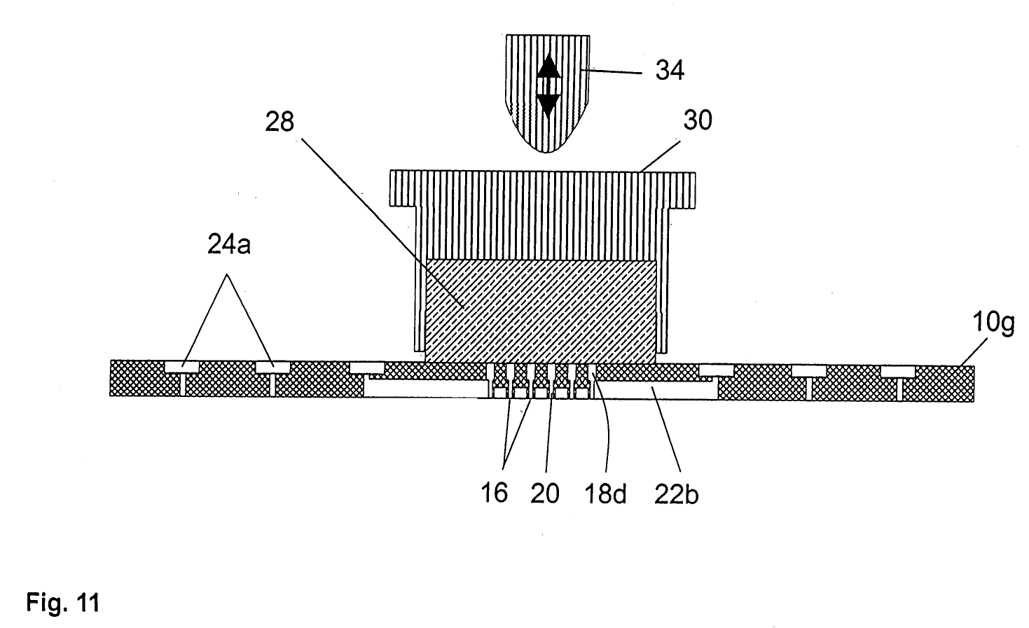

FIG. 11 shows a further modification in which the nozzles are contacted via media lines 22b in the bottom side of the dosing head substrate 10g. As there is a dead chamber 18e present in this case above the nozzle or nozzle opening 16, which is difficult to fill, it is expedient if the pressure head is filled first and the displacer 28 is arranged thereon only thereafter. In this case, it is again expedient that the deformable material is hydrophobic so that, upon application of the displacer, the liquid is urged back into the nozzle and cross-contamination due to wetting of the deformable material as a result of the capillary forces upon application of the displacer 28 is avoided.

For being able to produce a uniform volume displacement by the displacement means, i.e. the deformable component, in the nozzles or the portions thereof facing the deformable component; dummy channels or compensation channels may be utilized. One such compensation channel 50 is illustrated in exemplary form in the schematic plan view of FIG. 12 which illustrates furthermore nozzle openings 16, supply lines 20 and passages 36 with high flow resistance in exemplary fashion.

The compensation channels 50 are not filled with liquid and have the function of allowing the deformable material to expand thereinto while microdroplet discharge is effect, i.e. upon operation of the dosing head. The homogeneity of the deformation state can be enhanced thereby, and non-homogeneous stresses in the deformable material are avoided.

As pointed out hereinbefore, the deformable component in the embodiments described, in addition to the displacing effect, at the same time has a sealing effect and hermetically separates the various media in the various nozzles from each other. This reduces the risk of cross-contamination between various nozzles. The material parameters, e.g. the material strength and the compressibility of the deformable material, may be selected, for example, such that the pressure building up in the nozzles due to the acceleration of the liquids or due to the friction of the liquids on the nozzle walls, has no retroactive effect on the state of deformation of the deformable medium in the nozzles. In addition thereto, the material used for the deformable component is preferable a material of low compressibility, which is clearly lower than the comparable compressibility of air. Still more preferably, a non-compressible deformable material is employed, for example an elastomer, such as e.g. rubber or silicone. When such a material is deformed on the rear side by movement of the actuator, it will change its shape at another location, so that the volume in total remains constant. The effect hereof is that the elastomer, at the ends of the nozzles opposite the nozzle openings, will be deflected into the nozzles. The liquid thus is displaced directly from the nozzles and microdroplets are fired or ejected.

In addition to the embodiments described, in which the deformable component is directly adjacent the dosing head substrate, it is also possible to arrange an additional passive material between the deformable component and the dosing head substrate, for example a film that is permeable to air but impermeable to liquids. This could be advantageous, for example, in filling the system with liquid as air can escape on the side of the nozzles opposite the nozzle openings. This permits the volume displacement means to be mounted only after the filling process, while nevertheless avoiding a cross-contamination of liquids.

The deformable component according to the invention preferably consists of a massive solid body of a material that is deformable and preferably has low or no compressibility. Alternatively to the embodiments described hereinbefore, the deformable component could also be implemented by a bag filled with liquid.

FIGS. 13a and 13 finally show an alternative embodiment of a device according to the invention for ejecting a plurality of microdroplets, in which the dosing head substrate itself consists of a deformable material, for example an elastomer.

FIG. 13a illustrates the device in the inoperative state, whereas FIG. 13b shows the device in the operative state.

As illustrated in FIG. 13a, such a dosing head substrate 60 of a deformable material, for example an elastomer, such as e.g. rubber or silicone, may have a shape identical to that of the dosing head substrate 10c of the embodiment shown in FIG. 6. In like manner, the dosing head substrate of deformable material could also have a configuration corresponding to the configuration of the dosing head substrate of any of the other embodiments.

As illustrated in FIG. 13a, the dosing head substrate 60 is arranged between two rigid cover plates 62 and 64, the lower cover plate 64 being structured so as to leave free the portion of the array of nozzle openings 16, whereas the upper cover plate 62 is structured to define enlarged reservoir portions 66. When the rigid cover plates 62 and 64 are compressed, the dosing head substrate is squeezed, thereby reducing the cross-sectional areas and thus the volume of the nozzles or nozzle channels 20 and of the portions 18a, i.e. the media portions associated with the nozzles, as shown in FIG. 13b. Thus, liquid is displaced outwardly. The described compression of the dosing head substrate 60 is an axial compression, i.e. a compression towards the axes of the nozzles of the dosing head substrate.

Here, too, it is decisive for the ejection of liquid droplets that the volumes of the liquid-carrying lines or media portions connected to the nozzles are reduced by operation of the actuator. In case the dosing head substrate itself consists of a deformable material and operation is effected as described hereinbefore, the deformable material will deform in all directions that are not excluded by the rigid plates. The deformable dosing head substrate thus will bulge out e.g. from the edge portions of the dosing head, however with the cross-sectional areas of the liquid-carrying channels between reservoir and nozzle being reduced as well, as illustrated schematically in FIG. 13b.

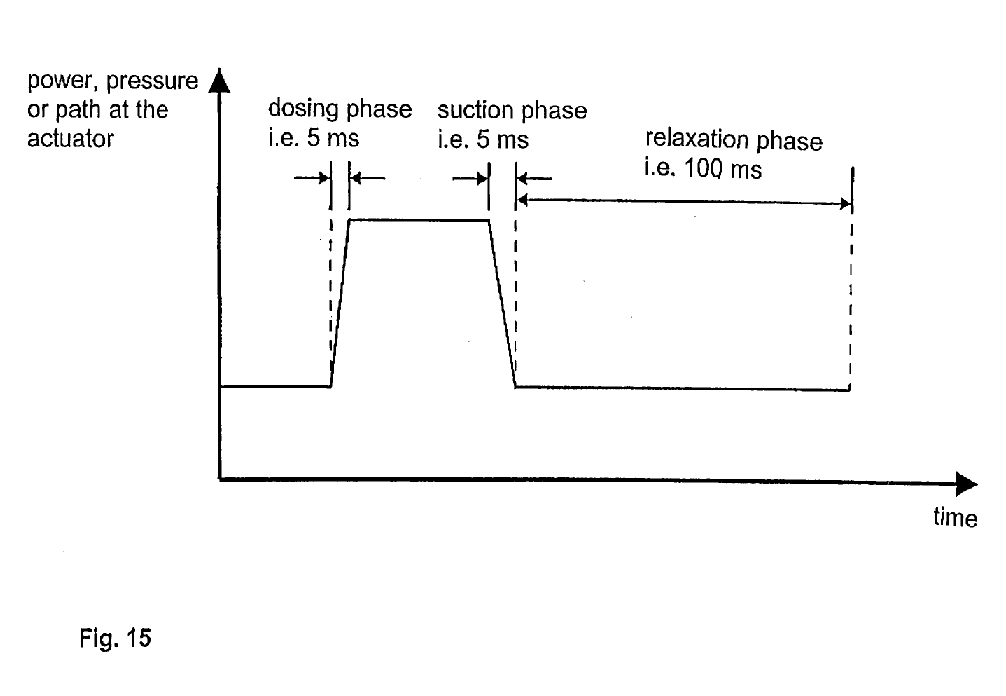

In the devices according to the invention for ejecting a plurality of microdroplets, the capillary forces in the channels, the surface tensions of the liquids at the nozzles as well as the flow resistances in the entirety of the media lines between nozzles and reservoirs may be matched to each other, for example, such that the time constant for the relaxation of the liquid column at the nozzle openings is e.g. in the range of 100 ms. If the motion of the actuator is performed e.g. within 5 ms, this is too fast for allowing compensation of the volumetric flow generated by the deformable component in connection with the relaxation. Prior to a new, defined ejection of liquid, the actuator has to be returned to the initial position (suction phase) and the relaxation time needs to expire. Two suitable processes in terms of time are schematically illustrated in FIGS. 14 and 15.

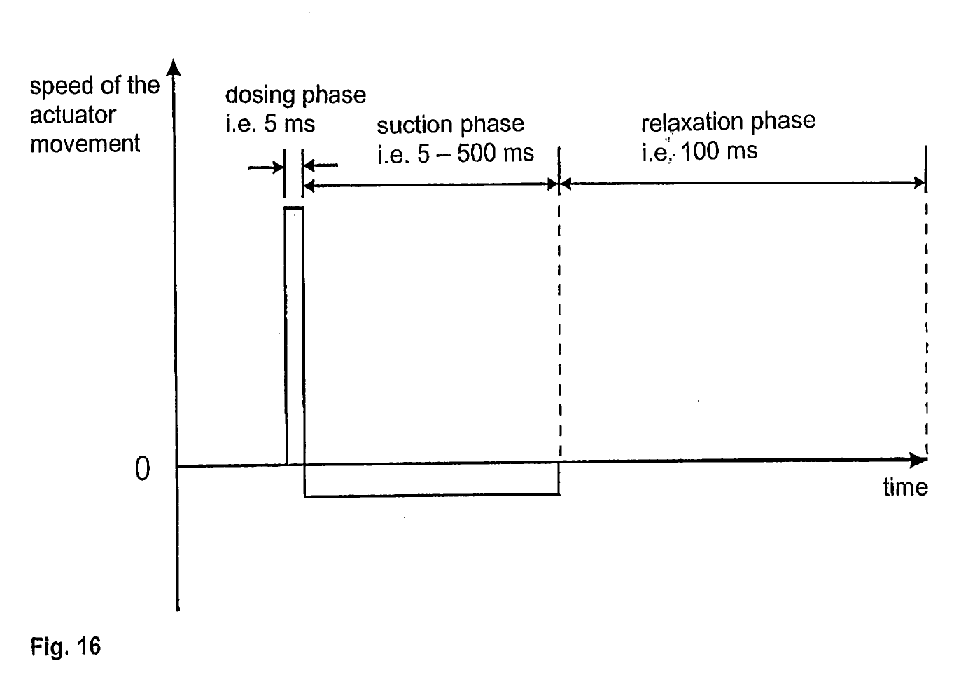

As an alternative, the respective socket or the respective counter-holding element may each be driven with a defined velocity profile as shown schematically in FIG. 16. The liquid in the region of the nozzle may thus be accelerated purposefully to an average speed of more than 1 to 2 m/s, a value which, according to experience, is necessary to effect tearing off of liquid droplets at the nozzles.

For filling the dosing head devices according to the invention, there are different variations conceivable, and filling can take place either prior to or after application of the displacer or deformable component.

In case filling is effected prior to application of the displacer, a gradually decreasing gap is formed between the media portions on the nozzle rear side and the deformable component upon application of the displacer. The deformable component as well as the portions surrounding supply channels in the facing surface of the dosing head substrate should therefore consist of a hydrophobic material or be coated with such a material. Otherwise, the liquid would be drawn into the ever decreasing capillary gap upon application of the displacer, resulting in a risk of cross-contamination of various liquids from various channels. As an alternative, as pointed out hereinbefore, it is possible to utilize a film that is permeable to air but resistant to liquid. Nevertheless, there may remain a residual risk as regards cross-contamination.

If filling takes place after application of the displacer, a cross-contamination between the various channels is indeed definitely excluded, but the filling operation now is considerably more difficult. Most of the deformable, rubber-like materials are hydrophobic, i.e. water-repellant, by nature. This has the result that the wall of the media portions constituted by the displacer, i.e. so to speak the “channel ceiling”, is wetted less by the liquid than the remaining walls, e.g. the channel floor. This may lead to entrapped air in the filling operation. However, the exact quantity of entrapped air often is not reproducible. As inclusions of air are compressible, they “absorb” part of the displaced volume. This may have the effect that the various channels, despite identical actuation, cause dosing of different quantities of liquid or that individual channels will not discharge liquid at all.

Another embodiment of a device according to the invention for applying a plurality of microdroplets onto a substrate in which there are reproducible quantities of entrapped air or entrapped buffer media, is illustrated in FIG. 17. In this embodiment, contrary to the embodiments described hereinbefore, there are provided buffer media portions between the deformable component and the media portions with the liquid to be dosed, as will be explained in more detail hereinafter.

In the embodiment illustrated in FIG. 17, the device according to the invention comprises a structured dosing head substrate 102 again having a plurality of nozzle openings 104 in the bottom side thereof. The nozzle openings again are in fluid communication with respective media portions 106 formed above the nozzle openings 104 in the dosing head substrate 102. As in case of the other embodiments, the media portions 106 again are connected to media reservoirs via one or plural connecting lines, one of which is illustrated at numeral 104 in exemplary manner.

Furthermore, there is provided a deformable component 110 having a socket 112, as described e.g. with reference to above FIG. 1. However, contrary to the embodiments described hereinbefore, the deformable component 110 is not directly adjacent the medium to be dosed, i.e. the media portion thereof, but acts on the medium to be dosed by way of a buffer medium. Each media portion 106 has a separate buffer media portion 114 associated therewith. The additional buffer media portion is realized in the embodiment shown in FIG. 17 by way of additional steps 116 in the dosing head substrate, which have the effect that the deformable component does not establish direct contact with the medium to be dosed. Thus, in the embodiment illustrated in FIG. 17, there is provided an entrapped buffer medium, e.g. air, with the volume of the entrapped buffer medium being reproducible as it is defined by the geometry of the recess.

To illustrate that the deformable component 110 does not establish contact with the medium to be dosed, the meniscuses forming in the liquid to be dosed are shown schematically in FIG. 17 and designated 118. It is to be pointed out here that, in the embodiment of the dosing device according to the invention, as shown in FIG. 17, the surfaces bearing the reference numerals 120 and 122 are preferably hydrophobic so as to aid the meniscus formation illustrated. These hydrophobic surfaces 120 are the surfaces of the steps 116 facing the deformable component 110. Optionally, the uppermost surface of the dosing head substrate 102 facing the deformable component may be hydrophobic as well, as indicated by reference numeral 122. In contrast thereto, the remaining surfaces in the nozzles and media portions are hydrophilic so that the liquid meniscuses each project from the nozzles and media portions and supply lines, respectively. It is evident that preferably the bottom surface of the dosing head substrate may be hydrophobic except for the supply lines and nozzle openings formed therein, so as to aid again the illustrated meniscus formation on the supply lines and nozzle openings, respectively, as indicated by reference numeral 124.

In the embodiment shown in FIG. 17, the lowering or recess in the media portions permits, furthermore, to apply the displacer optionally either prior to or after filling. In both cases, the quantity of the entrapped buffer medium, e.g. entrapped air, is defined in like manner by the geometry of the recess of the media portions, and thus is reproducible. The entrapped buffer medium as such acts like a fluid capacitance the size of which can be influenced by the volume of the entrapped buffer medium. It is thus possible to influence also the dynamics with which the liquid is ejected.

It is to be pointed out that the buffer media associated with each nozzle may be almost arbitrary media, provided that they do not mix with the liquid to be dosed. Feasible materials, in addition to the air mentioned, are other gases, oils and the like.

It is apparent to experts that the respective dosing head substrates, in addition to the structures illustrated and described, may have additional functional elements formed therein, such as e.g. reaction chambers, mixers, flow resistance means, pumps and the like. In addition thereto, electric conductive tracks or electric functional elements may be integrated therein as well.

In the devices according to the invention, the nozzles may have identical or different dimensions. In this regard, the devices according to the invention also comprise such devices in which two or more microdroplets per dosing operation are released from each of the nozzles or individual nozzles.

In addition thereto, the dosing head substrate may provide for a format conversion between a first pattern of reservoir openings and a second pattern of nozzle openings. Such an automatic conversion is achieved by the particular arrangement of the reservoirs and nozzle openings as well as by the supply channels extending between the same. It is thus possible to arrange the fluid reservoirs in a raster pattern of usual microtiter plates, having for example 96, 384 or 1536 chambers, and to transform the same, using fluid channels through the dosing head substrate, into a raster pattern of micro-nozzles in which analytes are to be applied to microarrays or biochips. It is thus possible to automatically fill the fluid reservoirs in parallel using conventional laboratory pipettes.

The present invention has a multiplicity of possible uses, for example, as pointed out hereinbefore, the production of so-called micro-arrays or biochips for bioanalytic applications. In addition thereto, the present invention can be utilized for the dosage of reagents in so-called microtiter plates, e.g. for highly parallel screening of new substances in the development of pharmaceutical drugs. Especially advantageous in this respect is the already mentioned reformatting of microtiter plates with a greater raster format into a microtiter plate of higher integration. Finally, the present invention may be utilized, for example, for applying solder or adhesive spots to electronic circuit boards or printed circuit boards.

1. A device for applying a plurality of microdroplets onto a substrate, comprising:
a dosing head substrate (10; 10a to 10g) having a plurality of nozzle openings (16; 16a) formed therein;
a media portion (18; 18a to 18d; 20a; 20b) for each nozzle opening (16; 16a), which is to be filled with a liquid to be dosed;
a deformable component (28; 28a to 28e) adjacent the plurality of media portions and resting on partition walls separating the media portions from each other, so that the media portions are mutually sealed; and
an actuating means (34) for actuating the deformable component (28; 28a to 28e) such that the deformable component deforms into the media portions so that microdroplets are simultaneously expelled from the plurality of nozzle openings (16; 16a) by liquid displacement effected by said deformation into the media portions.

2. A device according to claim 1, wherein the deformation of the deformable component (28; 28a to 28e) is effected by relative movement between a counter-holding element (30; 30a to 30f) and the dosing head substrate (10; 10a to 10g) having the deformable component arranged therebetween.

3. A device according to claim 1 or 2, wherein the counter-holding element (30) is a rigid socket for the deformable component (28), wherein the rigid socket, the deformable component (28) and the dosing head substrate (10; 10a; 10e; 10f) are arranged such that the rigid socket and the dosing head substrate surround most of the deformable component, except for the portions where the same is adjacent the media portions.

4. A device according to claim 1 or 2, wherein the deformable component (28a; 28b; 28c; 28d) and the counter-holding element (30a; 30b; 30c; 30d; 30e; 30f) are of plate-shaped configuration.

5. A device according to any of claims 1 to 4, wherein the deformable component (28; 28a to 28e) consists of a substantially incompressible material.

6. A device according to any of claims 1 to 5, wherein the deformable component (28; 28a to 28e) consists of a massive body.

7. A device according to any of claims 1 to 6, wherein the deformable component consists of an elastomer.

8. A device according to any of claims 1 to 7, wherein openings (38) of the media portions (18) adjacent the deformable component (28) have substantially identical cross-sectional profiles.

9. A device according to any of claims 1 to 8, wherein the openings (38) of the media portions (18) adjacent the deformable component (28) have a larger cross-sectional area than the nozzle openings (16).

10. A device according to any of claims 1 to 9, wherein the deformable component (28; 28a to 28e) is adjacent the media portions (18; 18a to 18d) such that openings (38) of the media portions are sealed with respect to each other.

11. A device according to any of claims 1 to 9, wherein a flexible layer that is permeable to air, but impermeable to liquids is arranged between the deformable component (28; 28a to 28e) and the dosing head substrate (10; 10a to 10g).

12. A device according to any of claims 1 to 11, wherein the dosing head substrate is provided with recessed portions (50) that are not to be filled with liquid and have the deformable component arranged adjacent thereto.

13. A device for applying a plurality of microdroplets onto a substrate, comprising:
a dosing head substrate (60) consisting of a deformable material and having a plurality of nozzle openings (16) formed therein, the dosing head substrate (60) having for each nozzle opening (16) a media portion (18a, 20) formed therein that is to be filled with a liquid to be dosed, and
a means (62, 64) for effecting deformation of the dosing head substrate (20) so as to simultaneously expel microdroplets from the plurality of nozzle openings (16).

14. A device according to claim 13, wherein the means for effecting deformation of the dosing head substrate (60) comprises two rigid components (62, 64) having the dosing head substrate (60) arranged therebetween, as well as an actuating member for effecting relative movement between the two rigid components (62, 64).

15. A device according to claim 13 or 14, wherein the dosing head substrate (60) consists of a substantially incompressible material.

16. A device according to any of claims 13 to 15, wherein the dosing head substrate (60) consists of an elastomer.

17. A device according to any of claims 1 to 16, wherein supply lines (22; 22a; 22b; 18a) for supplying liquids to the media portions are provided, the supply lines being designed such that the liquids are retained in the same by a capillary effect.

18. A device according to any of claims 1 to 17, wherein supply lines (22; 22a; 22b; 18) are formed, each connecting the media portions to a feed portion (24; 24a to 24c; 66), wherein the nozzle openings (16; 16a) are arranged in a first pattern on a first surface of the dosing head substrate and the feed portions are arranged in a second pattern on a second surface of the dosing head substrate located opposite the first surface thereof.

19. A device for applying a plurality of microdroplets onto a substrate according to claim 1, wherein each media portion has a separate buffer media portion (114);
the deformable component (110) is adjacent the buffer media portions; and
the actuating means actuates the deformable component (110) such that the deformable component deforms into the buffer media portions.

20. A method of applying a plurality of microdroplets onto a substrate, comprising the steps of:
providing one liquid-filled media portion (18; 18a to 18d; 20; 20a; 20b) each on a plurality of nozzle openings (16; 16a);
arranging a deformable component (28; 28a to 28e) adjacent the plurality of media portions and resting on partition walls separating the media portions from each other, so that the media portions are mutually sealed; and
displacing liquid from each of the media portions by producing a deformation of a deformable component (28; 28a to 28e) into the media portions so that a microdroplet is ejected from each nozzle opening due to the liquid displacement effected by said deformation of the deformable component.

21. A method of applying a plurality of microdroplets onto a substrate, comprising the steps of:
providing one liquid-filled media portion each on each of a plurality of nozzle openings (16), the nozzle openings (16) and media portions (18a, 20) being formed in a dosing head substrate (60) of a deformable material; and
producing a deformation of the dosing head substrate (60) such that microdroplets are expelled simultaneously from the plurality of nozzle openings (16).

22. A method of applying a plurality of microdroplets onto a substrate according to claim 20, wherein each media portion has a separate buffer media portion (114), and
liquid is displaced from each of the media portions by producing a deformation of a deformable component (110) adjacent the buffer media portions, into the buffer media portions.
